(19) United States
(12) Patent Application Publication
(10) Pub. No.: US 2010/0168356 A1
(43) Pub. Date: Jul. 1, 2010

(54) Biomedical Devices

(76) Inventors: Yu-Chin Lai, Pittsford, NY (US); Weihong Lang, Amston, CT (US); David Paul Vanderbilt, Webster, NY (US); Paul L. Valint, JR., Pittsford, NY (US); Joseph A. McGee, Canandaigua, NY (US)

Correspondence Address: Bausch & Lomb Incorporated, One Bausch & Lomb Place, Rochester, NY, 14604-2701, US

(21) Appl. No.: 12/641,464

(22) Filed: Dec. 18, 2009

Related U.S. Application Data
(60) Provisional application No. 61/203,936, filed on Dec. 30, 2008.

(51) Int. Cl. C08F 230/06

(52) U.S. Cl. 526/239

(57) ABSTRACT

Biomedical devices are provided herein which are formed from a polymerization product of a monomeric mixture comprising (a) a polymerizable monomer containing a boronic acid moiety and an electron withdrawing moiety; and (b) a biomedical device-forming comonomer.

This application claims the benefit of Provisional Patent Application No. 61/203,936 filed Dec. 30, 2008 which is incorporated by reference herein.

### BACKGROUND OF THE INVENTION

1. Technical Field

The present invention generally relates to biomedical devices, and especially ophthalmic devices that are intended for direct placement on or in the eye such as contact lenses or intraocular lenses.

2. Description of Related Art

In the field of biomedical devices such as contact lenses, various physical and chemical properties such as, for example, oxygen permeability, wettability, material strength and stability are but a few of the factors that must be carefully balanced in order to provide a useable contact lens. For example, since the cornea receives its oxygen supply exclusively from contact with the atmosphere, good oxygen permeability is a critical characteristic for any contact lens material. Wettability also is important in that, if the lens is not sufficiently wettable, it does not remain lubricated and therefore cannot be worn comfortably in the eye. Accordingly, the optimum contact lens would have at least both excellent oxygen permeability and excellent tear fluid wettability.

Hydrogels represent a desirable class of materials for many biomedical applications, including contact lenses and intraocular lenses. Hydrogels are hydrated, cross-linked polymeric systems that contain water in an equilibrium state. Silicone hydrogels are a known class of hydrogels and are characterized by the inclusion of a silicone-containing material. An advantage of silicone hydrogels over non-silicone hydrogels is that the silicone hydrogels typically have higher oxygen permeability due to the inclusion of the silicone-containing monomer. Hydrogels can absorb and retain water in an equilibrium state whereas non-hydrogels do not absorb appreciable amounts of water. Regardless of their water content, both non-hydrogel and hydrogel contact lenses tend to have relatively hydrophobic, non-wettable surfaces.

One way to alleviate this problem is by coating the surface of silicone hydrogel contact lenses with hydrophilic coatings, such as plasma coatings.

Polyvinylpyrrolidone (PVP) or poly-2-ethyl-2-oxazoline have been added to a hydrogel composition to form an interpenetrating network which shows a low degree of surface friction, a low dehydration rate and a high degree of biodeposit resistance. However, the hydrogel formulations disclosed are conventional hydrogels and there is no disclosure on how to incorporate hydrophobic components, such as siloxane monomers, without losing monomer compatibility.

Accordingly, it would be desirable to provide improved biomedical devices such as contact lenses that exhibit suitable physical and chemical properties, e.g., oxygen permeability, lubriciousness and wettability, for prolonged contact with the body while also being biocompatible.

### SUMMARY OF THE INVENTION

In accordance with one embodiment of the present invention, a biomedical device is provided which is obtained from a polymerization product of a monomeric mixture comprising (a) a polymerizable monomer containing a boronic acid moiety and an electron withdrawing moiety; and (b) a biomedical device-forming comonomer.

In accordance with a second embodiment of the present invention, a contact lens is provided which is obtained from a polymerization product of a monomeric mixture comprising (a) a polymerizable monomer containing a boronic acid moiety and an electron withdrawing moiety; and (b) a contact lens-forming comonomer.

The polymerizable monomers containing a boronic acid moiety and an electron withdrawing moiety for use in making the biomedical devices of the present invention, such as in a contact lens polymer formulation, are believed to provide enhanced wettability and/or lubriciousness to the contact lens. For example, the biomedical device would contain boronic acid moieties on the surface of the device which could then be coated with a hydrophilic polymer capable of providing enhanced wettability and lubriciousness to the resulting device.

### DETAILED DESCRIPTION OF THE PREFERRED EMBODIMENTS

The present invention is directed to biomedical devices intended for direct contact with body tissue or body fluid. As used herein, a “biomedical device” is any article that is designed to be used while either in or on mammalian tissues or fluid, and preferably in or on human tissue or fluids. Representative examples of biomedical devices include, but are not limited to, artificial ureters, diaphragms, intrauterine devices, heart valves, catheters, denture liners, prosthetic devices, ophthalmic lens applications, where the lens is intended for direct placement in or on the eye, such as, for example, intraocular devices and contact lenses. The preferred biomedical devices are ophthalmic devices, particularly contact lenses, and most particularly contact lenses made from silicone hydrogels.

As used herein, the term “ophthalmic device” refers to devices that reside in or on the eye. These devices can provide optical correction, wound care, drug delivery, diagnostic functionality or cosmetic enhancement or effect or a combination of these properties. Useful ophthalmic devices include, but are not limited to, ophthalmic lenses such as soft contact lenses, e.g., a soft, hydrogel lens, soft, non-hydrogel lens and the like, hard contact lenses, e.g., a hard, gas permeable lens material and the like, intraocular lenses, overlay lenses, ocular inserts, optical inserts and the like. As is understood by one skilled in the art, a lens is considered to be “soft” if it can be folded back upon itself without breaking.

The biomedical devices of the present invention are formed from a polymerization product of (a) a polymerizable monomer containing a boronic acid moiety and an electron withdrawing moiety; and (b) a biomedical device-forming comonomer. Suitable polymerizable monomers containing a boronic acid moiety and an electron withdrawing moiety for use in forming the biomedical devices of the present invention include boronic acid-containing monomers having an electron withdrawing moiety and one or more polymerizable ethylenically unsaturated-containing radicals attached thereto. Representative examples of a “polymerizable ethylenically unsaturated-containing radical” include, by way of example, (meth)acrylate-containing radicals, (meth)acrylamido-containing radicals, vinylcarbonate-containing radicals, vinylcarbamate-containing radicals, styrene-containing radicals, itaconate-containing radicals, vinyl-containing radicals, vinyloxy-containing radicals, fumarate-containing radicals, maleimide-containing radicals, vinylsulfonyl radicals and the like. As used herein, the term “(meth)” denotes an optional methyl substituent. Thus, for example, terms such as “(meth)acrylate” denotes either methacrylate or acrylate, and “(meth)acrylamide” denotes either methacrylamide or acrylamide.

In one embodiment, a polymerizable ethylenically unsaturated radical can be represented by the general formula:

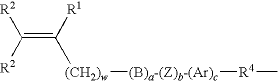

wherein R¹ is hydrogen or a alkyl group having 1 to 6 carbon atoms such as methyl; each R² is independently hydrogen, an alkyl radical having 1 to 6 carbon atoms, or a —CO—Y—R⁵ radical wherein Y is —O—, —S— or —NH— and R⁵ is an alkyl radical having 1 to about 10 carbon atoms; R⁴ is a linking group (e.g., a divalent alkenyl radical having 1 to about 12 carbon atoms); B denotes —O— or —NH—; Z denotes —CO—, —OCO— or COO—; Ar denotes an aromatic radical having 6 to about 30 carbon atoms; w is 0 to 6; a is 0 or 1; b is 0 or 1; and c is 0 or 1. The polymerizable ethylenically unsaturated-containing radicals can be attached to the boronic acid-containing monomers having an electron withdrawing moiety as pendent groups, terminal groups or both.

As used herein, the term “electron withdrawing moiety” refers to a group which has a greater electron withdrawing effect than hydrogen. A variety of electron-withdrawing moieties are known and include, by way of example, halogens (e.g., fluoro, chloro, bromo, and iodo groups), NO₂, NR₃⁺, CN, COOH(R), CF₃, and the like. The pH of the boronic acid-containing monomer can be adjusted by placing the electron withdrawing moiety in, e.g., a position meta to the boronic acid moiety on the phenyl ring.

Representative examples of suitable polymerizable monomers containing a boronic acid moiety and an electron withdrawing moiety include polymerizable ethylenically unsaturated alkyl boronic acids having an electron withdrawing moiety; polymerizable ethylenically unsaturated cycloalkyl boronic acids having an electron withdrawing moiety; polymerizable ethylenically unsaturated aryl boronic acids having an electron withdrawing moiety and the like and mixtures thereof. Preferred boronic acid polymerizable monomers are derived from 3-vinylphenylboronic acid or 3-methacrylamidophenylboronic acid.

Representative examples of alkyl groups for use herein include, by way of example, a straight or branched hydrocarbon chain radical containing carbon and hydrogen atoms of from 1 to about 18 carbon atoms with or without unsaturation, to the rest of the molecule, e.g., methyl, ethyl, n-propyl, 1-methylethyl (isopropyl), n-butyl, n-pentyl, etc., and the like.

Representative examples of cycloalkyl groups for use herein include, by way of example, a substituted or unsubstituted non-aromatic mono or multicyclic ring system of about 3 to about 24 carbon atoms such as, for example, cyclopropyl, cyclobutyl, cyclopentyl, cyclohexyl, perhydronapththyl, adamantyl and norbornyl groups bridged cyclic group or sprirobicyclic groups, e.g., sprio-(4, 4)-non-2-yl and the like, optionally containing one or more heteroatoms, e.g., O and N, and the like.

Representative examples of aryl groups for use herein include, by way of example, a substituted or unsubstituted monoaromatic or polyaromatic radical containing from about 5 to about 30 carbon atoms such as, for example, phenyl, naphthyl, tetrahydronapthyl, indenyl, biphenyl and the like, optionally containing one or more heteroatoms, e.g., O and N, and the like.

In one embodiment, a polymerizable monomer containing a boronic acid moiety and an electron withdrawing moiety is represented by the general formula:

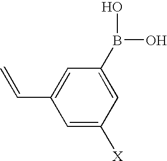

wherein X is an electron withdrawing group such as CF₃, —NO₂, —F, —Cl or Br.

The polymerizable monomers containing a boronic acid moiety and an electron withdrawing moiety can be prepared by the general reaction sequences set forth in Schemes I and II below:

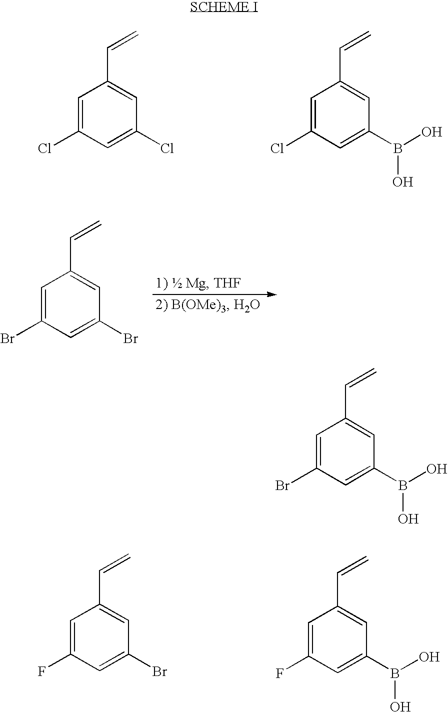

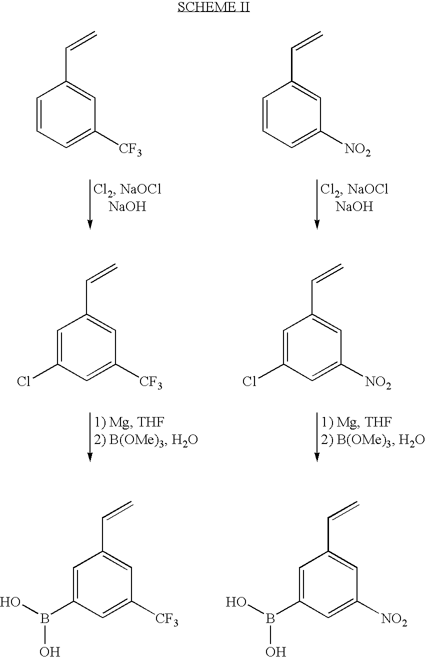

In addition to the polymerizable monomer containing a boronic acid moiety and an electron withdrawing moiety, the monomeric mixture will further contain one or more biomedical device-forming comonomers. Generally, the biomedical device-forming comonomer contains at least one polymerizable group. In one embodiment, the biomedical device-forming comonomer is an ophthalmic device-forming comonomer such as a contact lens-forming comonomer. In another embodiment, the biomedical device-forming comonomer is a hydrogel lens forming-containing monomer. Hydrogels comprise a hydrated, cross-linked polymeric system containing water in an equilibrium state. Accordingly, hydrogels are copolymers prepared from hydrophilic monomers. In the case of silicone hydrogels, the hydrogel copolymers are generally prepared by polymerizing a mixture containing at least one device-forming silicone-containing monomer and at least one device-forming hydrophilic monomer.

Either the silicone-containing monomer or the hydrophilic monomer may function as a crosslinking agent (a crosslinking agent being defined as a monomer having multiple polymerizable functionalities), or alternately, a separate crosslinking agent may be employed in the initial monomer mixture from which the hydrogel copolymer is formed. (As used herein, the term “monomer” or “monomeric” and like terms denote relatively low molecular weight compounds that are polymerizable by free radical polymerization, as well as higher molecular weight compounds also referred to as “prepolymers”, “macromonomers”, and related terms.) Silicone hydrogels typically have a water content between about 10 to about 80 weight percent.

Applicable silicone-containing monomers for use in the formation of contact lenses such as silicone hydrogels are well known in the art and numerous examples are provided in, for example, U.S. Pat. Nos. 4,136,250; 4,153,641; 4,740,533; 5,034,461; 5,070,215; 5,260,000; 5,310,779; and 5,358,995.

Representative examples of applicable silicon-containing monomers include bulky polysiloxanylalkyl(meth)acrylic monomers. An example of a bulky polysiloxanylalkyl(meth)acrylic monomer is represented by the structure of Formula I:

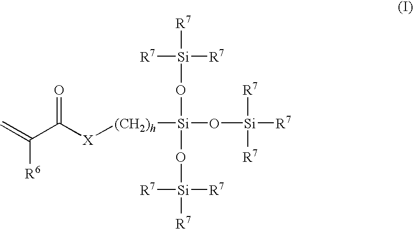

wherein X denotes —O— or —NR— wherein R denotes hydrogen or a C₁-C₄ alkyl; each R⁶ independently denotes hydrogen or methyl; each R⁷ independently denotes a lower alkyl radical, phenyl radical or a group represented by

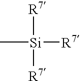

wherein each R⁷ independently denotes a lower alkyl or phenyl radical; and h is 1 to 10.

Representative examples of other applicable silicon-containing monomers includes, but are not limited to, bulky polysiloxanylalkyl carbamate monomers as generally depicted in Formula Ia:

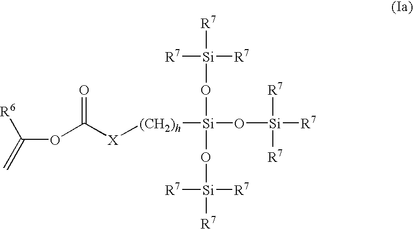

wherein X denotes —NR—; wherein R denotes hydrogen or a C₁-C₄ alkyl; R⁶ denotes hydrogen or methyl; each R⁷ independently denotes a lower alkyl radical, phenyl radical or a group represented by

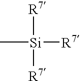

wherein each R^{7′} independently denotes a lower alkyl or phenyl radical; and h is 1 to 10, and the like.

Examples of bulky monomers are 3-methacryloyloxypropyltris(trimethyl-siloxy)silane or tris(trimethylsiloxy)silylpropyl methacrylate, sometimes referred to as TRIS and tris(trimethylsiloxy)silylpropyl vinyl carbamate, sometimes referred to as TRIS-VC and the like and mixtures thereof.

Such bulky monomers may be copolymerized with a silicone macromonomer, which is a poly(organosiloxane) capped with an unsaturated group at two or more ends of the molecule. U.S. Pat. No. 4,153,641 discloses, for example, various unsaturated groups such as acryloxy or methacryloxy groups.

Another class of representative silicone-containing monomers includes, but is not limited to, silicone-containing vinyl carbonate or vinyl carbamate monomers such as, for example, 1,3-bis[4-vinyloxycarbonyloxy)but-1-yl]tetramethyldisiloxane; 3-(trimethylsilyl)propyl vinyl carbonate; 3-(vinyloxycarbonylthio)propyl-[tris(trimethylsiloxy)silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; trimethylsilylmethyl vinyl carbonate and the like.

Another class of silicon-containing monomers includes polyurethane-polysiloxane macromonomers (also sometimes referred to as prepolymers), which may have hard-soft-hard blocks like traditional urethane elastomers. Examples of silicone urethanes are disclosed in a variety or publications, including Lai, Yu-Chin, “The Role of Bulky Polysiloxanylalkyl Methacryates in Polyurethane-Polysiloxane Hydrogels,” Journal of Applied Polymer Science, Vol. 60, 1193-1199 (1996). PCT Published Application No. WO 96/31792 also discloses examples of such monomers, the contents of which are hereby incorporated by reference in its entirety. Further examples of silicone urethane monomers are represented by Formulae II and III:

E(*D*A*D*G)ₐ*D*A*D*E′; or (II)

E(*D*G*D*A)ₐ*D*A*D*E′; or (III)

wherein:

D denotes an alkyl diradical, an alkyl cycloalkyl diradical, a cycloalkyl diradical, an aryl diradical or an alkylaryl diradical having 6 to about 30 carbon atoms;

G denotes an alkyl diradical, a cycloalkyl diradical, an alkyl cycloalkyl diradical, an aryl diradical or an alkylaryl diradical having 1 to about 40 carbon atoms and which may contain ether, thio or amine linkages in the main chain;
* denotes a urethane or ureido linkage;

a is at least 1;

A denotes a divalent polymeric radical of Formula IV:

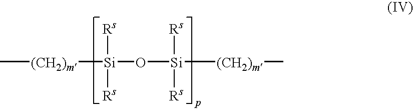

wherein each R^{s} independently denotes an alkyl or fluoro-substituted alkyl group having 1 to about 10 carbon atoms which may contain ether linkages between the carbon atoms; m′ is at least 1; and p is a number that provides a moiety weight of about 400 to about 10,000;

each of E and E′ independently denotes a polymerizable unsaturated organic radical represented by Formula V:

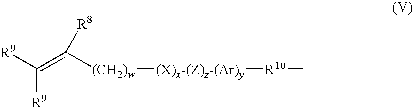

wherein: R⁸ is hydrogen or methyl;
R⁹ is independently hydrogen, an alkyl radical having 1 to 6 carbon atoms, or a —CO—Y—R¹¹ radical wherein Y is —O—, —S— or —NH—;
R¹⁰ is a divalent alkylene radical having 1 to about 10 carbon atoms;
R¹¹ is a alkyl radical having 1 to about 12 carbon atoms;
X denotes —CO— or —OCO—;
Z denotes —O— or —NH—;
Ar denotes an aromatic radical having about 6 to about 30 carbon atoms;
w is 0 to 6; x is 0 or 1; y is 0 or 1; and z is 0 or 1.

A preferred silicone-containing urethane monomer is represented by Formula VI:

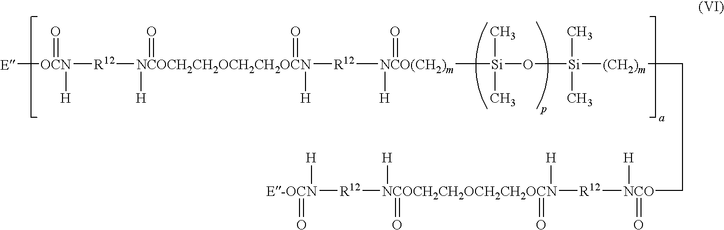

wherein m is at least 1 and is preferably 3 or 4, a is at least 1 and preferably is 1, p is a number which provides a moiety weight of about 400 to about 10,000 and is preferably at least about 30, R¹² is a diradical of a diisocyanate after removal of the isocyanate group, such as the diradical of isophorone diisocyanate, and each F′ is a group represented by:

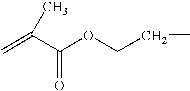

Another class of representative silicone-containing monomers includes fluorinated monomers. Such monomers have been used in the formation of fluorosilicone hydrogels to reduce the accumulation of deposits on contact lenses made therefrom, as described in, for example, U.S. Pat. Nos. 4,954,587; 5,010,141 and 5,079,319. The use of silicone-containing monomers having certain fluorinated side groups, i.e., —(CF₂)—H, have been found to improve compatibility between the hydrophilic and silicone-containing monomeric units, see, e.g., U.S. Pat. Nos. 5,321,108 and 5,387,662.

The above silicone materials are merely exemplary, and other materials for use in forming biomedical devices according to the present invention and have been disclosed in various publications and are being continuously developed for use in contact lenses and other biomedical devices can also be used. For example, a biomedical device-forming comonomer can be a cationic monomer such as cationic silicone-containing monomer or cationic fluorinated silicone-containing monomers.

The monomer mixtures can also contain one or more hydrophilic monomers. Suitable hydrophilic monomers include one or more unsaturated carboxylic acids, vinyl lactams, amides, polymerizable amines, vinyl carbonates, vinyl carbamates, oxazolone monomers, and the like and mixtures thereof. Useful unsaturated carboxylic acids include methacrylic acid or acrylic acid. Useful amides include acrylamides such as N,N-dimethylacrylamide and N,N-dimethylmethacrylamide. Useful vinyl lactams include cyclic lactams such as N-vinyl-2-pyrrolidone. Examples of other hydrophilic monomers include poly(alkene glycols) functionalized with polymerizable groups. Examples of useful functionalized poly(alkene glycols) include poly(diethylene glycols) of varying chain length containing monomethacrylate or dimethacrylate end caps. In a preferred embodiment, the poly(alkene glycol) polymer contains at least two alkene glycol monomeric units. Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277. Other suitable hydrophilic monomers will be apparent to one skilled in the art. The hydrophilic monomers can be present in the monomeric mixtures in an amount ranging from 0 to about 70 weight percent, based on the total weight of the mixture.

The monomer mixtures can also contain one or more hydrophobic monomers. Suitable hydrophobic monomers include C₁-C₂₀ alkyl and C₃-C₂₀ cycloalkyl (meth)acrylates, substituted and unsubstituted C₆-C₃₀ aryl (meth)acrylates, (meth)acrylonitriles, fluorinated alkyl methacrylates, long-chain acrylamides such as octyl acrylamide, and the like. The hydrophobic monomers can be present in the monomeric mixtures in an amount ranging from 0 to about 30 weight percent, based on the total weight of the mixture.

The monomer mixtures can also contain one or more crosslinking monomers. The crosslinking monomer may be a material having multiple polymerizable functionalities, preferably vinyl functionalities. Representative examples of crosslinking monomers include divinylbenzene; allyl methacrylate; ethyleneglycol di(meth)acrylate, tetraethyleneglycol di(meth)acrylate, polyethyleneglycol di(meth)acrylate; vinylcarbonate derivatives of the glycol di(meth)acrylates and the like. The crosslinking monomers can be present in the monomeric mixtures in an amount ranging from 0 to about 40 weight percent, based on the total weight of the mixture.

In order to prepare the biomedical devices of the present invention that are capable of complexation with coating polymers such as a hydrophilic polymer, it is necessary that the boronic acid groups are present at the surface of the device and are capable of forming complexes with suitable coating polymers at physiological pH (e.g. a pH of about 6.8 to about 7.6). Concentration of the boronic acid groups at the surface of the biomedical device can be accomplished by providing a mold surface that is capable of complexation with boronic acid groups. A mold surface having any of the following functional groups are capable of complexation with boronic acid groups: 1,2 diols, 1,3 diols, dicarboxylic acids, α-hydroxy carboxylic acids and the like. Representative examples of suitable mold materials are ethyl vinyl alcohol resin, poly(ethylene-co-vinyl alcohol), air-plasma oxidized polypropylene and the like.

To meet the pKa requirement, boronic acid groups such as aryl boronic acids are commonly copolymerized with tertiary amines so that some of the amine groups are placed adjacent to the boronic acid groups to interact with the boronic acid groups and lower the effective pKa of the boronic acid to the about 6.8 to about 7.6 range. However, the addition of a polymerizable tertiary amine to a contact lens formulation at a low concentration is generally not desirable because the probability of forming boronic acid—tertiary amine dimer sequences is relatively low. The present invention advantageously employs boronic acid monomers having an electron withdrawing substituent to obviate the need to incorporate a tertiary amine into, for example, a lens formulation, while being able to meet the pKa requirement and allow the boronic acid groups to be present at the surface of the lens.

If desired, the monomer mixtures may also contain a monomer having a tertiary-amine moiety such that the boronic acid moieties on the surface of the biomedical device are physiologically acceptable, i.e., a pH value of about 6.8 to about 7.6 (physiological pH values). Examples of monomers copolymerizable with the boronic acid monomer are ethylenically unsaturated monomers containing the tertiary-amine moiety. Specific examples include: 2-(N,N-dimethyl)ethylamino(meth)acrylate, N-[2-(dimethylamino)ethyl](meth)acrylamide, N-[(3-dimethylamino)propyl](meth)acrylate, N-[3-dimethylamino)propyl](meth)acrylamide and vinylbenzyl-N,N-dimethylamine.

The biomedical devices of the present invention, e.g., contact lenses or intraocular lenses, can be prepared by polymerizing the foregoing monomeric mixtures to form a product that can be subsequently formed into the appropriate shape by, for example, lathing, injection molding, compression molding, cutting and the like. For example, in producing contact lenses, the initial monomeric mixture may be polymerized in tubes to provide rod-shaped articles, which are then cut into buttons. The buttons may then be lathed into contact lenses.

Alternately, the contact lenses may be cast directly in molds, e.g., polypropylene molds, from the monomeric mixtures, e.g., by spincasting and static casting methods. Spincasting methods are disclosed in U.S. Pat. Nos. 3,408,429 and 3,660,545, and static casting methods are disclosed in U.S. Pat. Nos. 4,113,224, 4,197,266, and 5,271,875. Spincasting methods involve charging the monomer mixture to a mold, and spinning the mold in a controlled manner while exposing the monomer mixture to a radiation source such as UV light. Static casting methods involve charging the monomeric mixture between two mold sections, one mold section shaped to form the anterior lens surface and the other mold section shaped to form the posterior lens surface, and curing the monomeric mixture while retained in the mold assembly to form a lens, for example, by free radical polymerization of the monomeric mixture. Examples of free radical reaction techniques to cure the lens material include thermal radiation, infrared radiation, electron beam radiation, gamma radiation, ultraviolet (UV) radiation, and the like; or combinations of such techniques may be used. U.S. Pat. No. 5,271,875 describes a static cast molding method that permits molding of a finished lens in a mold cavity defined by a posterior mold and an anterior mold. As an additional method, U.S. Pat. No. 4,555,732 discloses a process where an excess of a monomeric mixture is cured by spincasting in a mold to form a shaped article having an anterior lens surface and a relatively large thickness, and the posterior surface of the cured spincast article is subsequently lathed to provide a contact lens having the desired thickness and posterior lens surface.

Polymerization may be facilitated by exposing the mixture to heat and/or radiation, such as ultraviolet light, visible light, or high energy radiation. A polymerization initiator may be included in the mixture to facilitate the polymerization step. Representative examples of free radical thermal polymerization initiators include organic peroxides such as acetal peroxide, lauroyl peroxide, decanoyl peroxide, stearoyl peroxide, benzoyl peroxide, tertiarylbutyl peroxypivalate, peroxydicarbonate, and the like. Representative UV initiators are those known in the art and include benzoin methyl ether, benzoin ethyl ether, Darocure 1173, 1164, 2273, 1116, 2959, 3331 (EM Industries) and Igracure 651 and 184 (Ciba-Geigy), and the like. Generally, the initiator will be employed in the monomeric mixture at a concentration of about 0.01 to 1 percent by weight of the total mixture.

Polymerization of the mixtures will yield a polymer, that when hydrated, forms a hydrogel. Generally, the mixture will contain the polymerizable monomer having one or more boronic acid moieties in an amount ranging from about 0.1 to about 10 weight percent, and preferably from about 0.5 to about 2 weight percent, based on the total weight of the mixture, and the biomedical device-forming comonomer in an amount ranging from about 5 to about 90 weight percent and preferably from about 20 to about 60 weight percent, based on the total weight of the mixture.

When producing a hydrogel lens, the mixture may further include at least a diluent that is ultimately replaced with water when the polymerization product is hydrated to form a hydrogel. Generally, the water content of the hydrogel is greater than about 5 weight percent and more commonly between about 10 to about 80 weight percent. The amount of diluent used should be less than about 50 weight percent and in most cases, the diluent content will be less than about 30 weight percent. However, in a particular polymer system, the actual limit will be dictated by the solubility of the various monomers in the diluent. In order to produce an optically clear copolymer, it is important that a phase separation leading to visual opacity does not occur between the comonomers and the diluent, or the diluent and the final copolymer.

Furthermore, the maximum amount of diluent which may be used will depend on the amount of swelling the diluent causes the final polymers. Excessive swelling will or may cause the copolymer to collapse when the diluent is replaced with water upon hydration. Suitable diluents include, but are not limited to, ethylene glycol; glycerine; liquid poly(ethylene glycol); alcohols; alcohol/water mixtures; ethylene oxide/propylene oxide block copolymers; low molecular weight linear poly(2-hydroxyethyl methacrylate); glycol esters of lactic acid; formamides; ketones; dialkylsulfoxides; butyl carbitol; and the like and mixtures thereof.

As previously stated, the biomedical devices of the present invention, such as a contact lens, should have a sufficient amount of concentrated boronic acid on the surface to provide enhanced wettability and/or lubriciousness to the lens. One manner to accomplish this is to cast the monomer mix in an appropriate mold resin such as an ethyl vinyl alcohol resin and then wet release of the lens from the mold. Another manner is to incorporate the boronic acid-containing monomer into a surface active monomer, see, e.g., U.S. Pat. Nos. 5,117,165 and 5,219,965.

If necessary, it may be desirable to remove residual diluent from the lens before edge-finishing operations which can be accomplished by evaporation at or near ambient pressure or under vacuum. An elevated temperature can be employed to shorten the time necessary to evaporate the diluent. The time, temperature and pressure conditions for the solvent removal step will vary depending on such factors as the volatility of the diluent and the specific monomeric components, as can be readily determined by one skilled in the art. If desired, the mixture used to produce the hydrogel lens may further include crosslinking and wetting agents known in the prior art for making hydrogel materials.

The biomedical devices such as contact lenses obtained herein may be subjected to optional machining operations. For example, the optional machining steps may include buffing or polishing a lens edge and/or surface. Generally, such machining processes may be performed before or after the product is released from a mold part, e.g., the lens is dry released from the mold by employing vacuum tweezers to lift the lens from the mold, after which the lens is transferred by means of mechanical tweezers to a second set of vacuum tweezers and placed against a rotating surface to smooth the surface or edges. The lens may then be turned over in order to machine the other side of the lens.

The lens may then be transferred to an individual lens package containing a buffered saline solution. The saline solution may be added to the package either before or after transfer of the lens. Appropriate packaging designs and materials are known in the art. A plastic package is releasably sealed with a film. Suitable sealing films are known in the art and include foils, polymer films and mixtures thereof. The sealed packages containing the lenses are then sterilized to ensure a sterile product. Suitable sterilization means and conditions are known in the art and include, for example, autoclaving.

As one skilled in the art will readily appreciate, other steps may be included in the molding and packaging process described above. Such other steps can include, for example, coating the formed lens, surface treating the lens during formation (e.g., via mold transfer), inspecting the lens, discarding defective lenses, cleaning the mold halves, reusing the mold halves, and the like and combinations thereof.

The following examples are provided to enable one skilled in the art to practice the invention and are merely illustrative of the invention. The examples should not be read as limiting the scope of the invention as defined in the claims.

In the example, the following abbreviations are used.

TRIS: tris(trimethylsiloxy)silylpropyl methacrylate

NVP: N-vinyl-2-pyrrolidone

HEMA: 2-hydroxyethyl methacrylate

HEMAVC: methacryloxyethyl vinyl carbonate

Vazo™ 64: a thermal polymerization initiator, said to be 2,2′-azobisisobutyronitrile (DuPont Chemicals, Wilmington, Del.)

IMV T: 1,4-bis(4-(2-methacryloxyethyl)phenylamino)anthraquinone

### Example 1

### Preparation of a Contact Lens

Mixtures were made by mixing the following components listed in Table 1, at amounts per weight.

TABLE 1

| | Weight |
|---|---|
| Ingredient | Percent |
| Polyurethane-siloxane | 53 |
| prepolymer | |
| TRIS | 15 |
| NVP | 33 |
| HEMA | 5 |
| HEMAVC | 1 |
| Boronic acid monomer | 1 |
| N-hexanol | 15 |
| Vazo-64 | 0.5 |
| IMVT | 150 ppm |

The resulting mixture is cast into contact lenses by introducing the mixture to a mold assembly composed of an ethyl vinyl alcohol mold for the anterior surface and an ethyl vinyl alcohol mold for the posterior surface and thermally curing the mixture at 100° C. for 2 hours. The resulting contact lens is released from the mold, extracted with isopropyl alcohol for 4 hours and placed in buffer solution. The boronic acid monomer used in this example is of the formula:

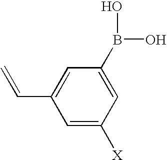

wherein X is —NO₂.

It will be understood that various modifications may be made to the embodiments disclosed herein. Therefore the above description should not be construed as limiting, but merely as exemplifications of preferred embodiments. For example, the functions described above and implemented as the best mode for operating the present invention are for illustration purposes only. Other arrangements and methods may be implemented by those skilled in the art without departing from the scope and spirit of this invention. Moreover, those skilled in the art will envision other modifications within the scope and spirit of the features and advantages appended hereto.

What is claimed is:

1. A biomedical device which is obtained from a polymerization product of a monomeric mixture comprising (a) a polymerizable monomer containing a boronic acid moiety and an electron withdrawing moiety; and (b) a biomedical device-forming comonomer.

2. The biomedical device of claim 1, wherein the electron withdrawing moiety is CF₃, —NO₂, —F, —Cl or Br.

3. The biomedical device of claim 1, wherein the polymerizable monomer containing a boronic acid moiety and an electron withdrawing moiety comprises a polymerizable ethylenically unsaturated containing aryl boronic acid.

4. The biomedical device of claim 1, wherein the polymerizable monomer containing a boronic acid moiety comprises a 3-vinylphenylboronic acid or 3-methacrylamidophenylboronic acid.

5. The biomedical device of claim 1, wherein the biomedical device-forming comonomer is a silicone-containing monomer.

6. The biomedical device of claim 1, wherein the monomeric mixture further comprises a hydrophilic monomer, hydrophobic monomer or both.

7. The biomedical device of claim 6, wherein the hydrophilic monomer is selected from the group consisting of an unsaturated carboxylic acid, vinyl lactam, amide, polymerizable amine, vinyl carbonate, vinyl carbamate, oxazolone monomer and mixtures thereof.

8. The biomedical device of claim 6, wherein the hydrophilic monomer is selected from the group consisting of 2-hydroxyethylmethacrylate, 2-hydroxyethylacrylate, glyceryl methacrylate, N-vinyl pyrrolidone, N-vinyl-N-methyl acetamide, N,N-dimethyl methacrylamide, N,N-dimethylacrylamide, acrylic acid, methacrylic acid and mixtures thereof.

9. The biomedical device of claim 6, wherein the hydrophobic monomer is selected from the group consisting of a C₁-C₂₀ alkyl (meth)acrylate, substituted and unsubstituted C₃-C₂₀ cycloalkyl (meth)acrylate, substituted and unsubstituted C₆-C₃₀ aryl (meth)acrylates, (meth)acrylonitriles, fluorinated alkyl methacrylates and mixtures thereof.

10. The biomedical device of claim 6, wherein the hydrophobic monomer is a silicone-containing monomer having from 1 to about 20 silicon atoms.

11. The biomedical device of claim 10, wherein the silicone monomer is 3-methacryloxypropyl tris(trimethylsiloxy)silane.

12. The biomedical device of claim 6, wherein the hydrophobic monomer is an aliphatic ring containing monomer selected from the group consisting of isobornyl acrylate, isobornyl methacrylate, cyclohexyl acrylate, cyclohexyl methacrylate and mixtures thereof.

13. The biomedical device of claim 1, wherein component (a) comprises about 0.1 to about 10 weight percent and the biomedical device-forming comonomer component (b) comprises about 5 to about 90 weight percent, based on the total weight of the mixture.

14. The biomedical device of claim 1, wherein component (a) comprises about 0.5 to about 2 weight percent and the biomedical device-forming comonomer component (b) comprises about 20 to about 60 weight percent, based on the total weight of the mixture.

15. The biomedical device of claim 1, which is an ophthalmic lens.

16. The biomedical device of claim 15, wherein the ophthalmic lens is a contact lens.

17. The biomedical device of claim 16, wherein the contact lens is a rigid gas permeable lens or a soft contact lens.

18. The biomedical device of claim 1, which is a silicone hydrogel.

19. The biomedical device of claim 1, which is an intraocular lens.

20. The biomedical device of claim 1, which is a corneal implant.
